(19) United States
(12) Patent Application Publication
(10) Pub. No.: US 2023/0282033 A1
(43) Pub. Date: Sep. 7, 2023

(54) SYSTEM AND METHOD FOR VALIDATING DIAGNOSTIC TROUBLE CODES GENERATED BY ONBOARD DIAGNOSTICS SYSTEMS OF VEHICLES

(71) Applicants: GM GLOBAL TECHNOLOGY OPERATIONS LLC, Detroit, MI (US); NORTHEASTERN UNIVERSITY, Boston, MA (US)

(72) Inventors: Shiming Duan, Ann Arbor, MI (US); Yingjie Cai, Royal Oak, MI (US); Paul R. Hozak, Highland, MI (US); Fernando Ferreira Pio, Commerce, MI (US); Gregory Sapick, Bloomfield Hills, MI (US); Xiaomeng Peng, Malden, MA (US)

(21) Appl. No.: 17/687,221

(22) Filed: Mar. 4, 2022

(51) Int. Cl. G07C 5/00

(52) U.S. Cl. CPC G07C 5/006

(57) ABSTRACT

A system for validating diagnostic trouble codes (DTCs) in vehicles includes a processor and a memory storing instructions which when executed by the processor configure the processor to receive DTC data from the vehicles, filter the DTC data using predefined rules, generate one or more metrics based on the filtered DTC data, and determining based on the metrics whether the DTCs meet specifications for the DTCs.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to onboard diagnostics systems of vehicles and more particularly to a system and method for validating diagnostic trouble codes generated by the onboard diagnostics systems of vehicles.

Onboard diagnostics (OBD) are performed on various subsystems used in vehicles to ensure that the subsystems operate normally and to detect if any faults occur or are about to occur in the subsystems. When a fault occurs or is about to occur in a subsystem, the OBD for the subsystem generates a diagnostic trouble code (DTC). The DTC is typically displayed on the dashboard of the vehicle or provided in the form of an alert to the driver of the vehicle in any other suitable manner (e.g., via an audiovisual indication). In response, the driver can take appropriate action (e.g., schedule service) based on the DTC. The DTC can assist service personnel in troubleshooting and fixing the fault.

### SUMMARY

A system for validating diagnostic trouble codes (DTCs) in vehicles comprises a processor and a memory storing instructions which when executed by the processor configure the processor to receive DTC data from the vehicles, filter the DTC data using predefined rules, generate one or more metrics based on the filtered DTC data, and determining based on the metrics whether the DTCs meet specifications for the DTCs.

In other features, the processor is configured to detect problems with the DTCs based on the metrics and the predefined rules, correlate the problems with software and calibration versions used to generate the DTCs, vehicle identification numbers (VINs) of the vehicles, and environmental variables, and identify a root cause for the problems with the DTCs.

In another feature, the processor is configured to provide an indication regarding updating software or calibration versions based on the correlation with the software and calibration versions.

In another feature, the processor is configured to provide an indication regarding servicing one or more of the vehicles based on the correlation with the VINs.

In another feature, the processor is configured to provide an indication regarding modifying at least one of the software or calibration versions based on the correlation with the VINs.

In other features, the processor is configured to filter the DTC data based on one or more of whether the DTC data is from a test vehicle, conditions to generate the DTCs are met for each drive cycle, the DTCs were reset after corresponding fault was cleared, the DTCs are generated after the vehicles have been driven for a period of time, and whether variables used to generate the metrics are within respective ranges of default values.

In other features, one of the metrics is an in-use monitor performance ratio (IUMPR). The processor is configured to determine whether one of the DTCs meets a corresponding specification based on whether the IUMPR for the one of the DTCs is within a predetermined range.

In other features, one of the metrics is of a ratio type, and the processor is configured to determine whether one of the DTCs meets a corresponding specification based on whether a ratio of a variable for the one of the DTCs to a corresponding threshold is within a predetermined limit.

In other features, one of the metrics is of a statistical type, and the processor is configured to determine whether one of the DTCs meets a corresponding specification based on whether a mean value of a variable for the one of the DTCs is a predetermined number of standard deviations away from a corresponding threshold.

In other features, the processor is configured to detect outliers in data corresponding to a variable selected as a figure of merit variable for one of the DTCs, correlate the outliers with software and calibration versions used to generate the DTCs, vehicle identification numbers (VINs) of the vehicles, and environmental variables, and identify a root cause for the problems with the one of the DTCs.

In still other features, a method for validating diagnostic trouble codes (DTCs) in vehicles comprises receiving DTC data from the vehicles, filtering the DTC data using predefined rules, generating one or more metrics based on the filtered DTC data, and determining based on the metrics whether the DTCs meet specifications for the DTCs.

In other features, the method further comprises detecting problems with the DTCs based on the metrics and the predefined rules; correlating the problems with software and calibration versions used to generate the DTCs, vehicle identification numbers (VINs) of the vehicles, and environmental variables; and identifying a root cause for the problems with the DTCs.

In another feature, the method further comprises providing an indication regarding updating software or calibration versions based on the correlation with the software and calibration versions.

In another feature, the method further comprises providing an indication regarding servicing one or more of the vehicles based on the correlation with the VINs.

In another feature, the method further comprises providing an indication regarding modifying at least one of the software or calibration versions based on the correlation with the VINs.

In other features, the method further comprises filtering the DTC data based on one or more of whether the DTC data is from a test vehicle, conditions to generate the DTCs are met for each drive cycle, the DTCs were reset after corresponding fault was cleared, the DTCs are generated after the vehicles have been driven for a period of time, and whether variables used to generate the metrics are within respective ranges of default values.

In other features, one of the metrics is an in-use monitor performance ratio (IUMPR). The method further comprises determining whether one of the DTCs meets a corresponding specification based on whether the IUMPR for the one of the DTCs is within a predetermined range.

In other features, one of the metrics is of a ratio type, and the method further comprises determining whether one of the DTCs meets a corresponding specification based on whether a ratio of a variable for the one of the DTCs to a corresponding threshold is within a predetermined limit.

In other features, one of the metrics is of a statistical type, the method further comprises determining whether one of the DTCs meets a corresponding specification based on whether a mean value of a variable for the one of the DTCs is a predetermined number of standard deviations away from a corresponding threshold.

In other features, the method further comprises detecting outliers in data corresponding to a variable selected as a figure of merit variable for one of the DTCs; correlating the outliers with software and calibration versions used to generate the DTCs, vehicle identification numbers (VINs) of the vehicles, and environmental variables; and identifying a root cause for the problems with the one of the DTCs.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a plurality of subsystems of a vehicle connected to each other using a Controlled Area Network (CAN) bus in the vehicle;

FIG. 2 shows an example of a distributed network system comprising a plurality of servers and a plurality of the vehicle shown in FIG. 1;

FIG. 3 shows an example of a server used in the distributed network system of FIG. 2;

FIG. 4 shows a method of validating diagnostics trouble codes (DTCs) generated by onboard diagnostics (ODS) systems in vehicles using the distributed network system of FIG. 2;

FIG. 5 shows a method of defining rules used for validating the DTCs;

FIG. 6 shows a method of filtering DTC data used in validating the DTCs;

FIGS. 7A and 7B show methods of generating metrics used in validating the DTCs;

FIGS. 8A and 8B show methods of detecting issues with the DTCs using the metrics;

FIGS. 9A-9C show methods of correlating the detected issues with software and/or calibration used to generate the DTCs, vehicle identification numbers (VINs), and environmental variables;

FIG. 10 shows a method for determining root causes for the detected issues with the DTCs; and

FIG. 11 shows a method for categorizing the detected issues with the DTCs and providing suggestions to address the detected issues with the DTCs.

In the drawings, reference numbers may be reused to identify similar and/or identical elements.

### DETAILED DESCRIPTION

Performance of diagnostic trouble codes (DTCs), or accuracy with which the DTCs indicate statuses of various subsystems of vehicles, can impact vehicle emissions, safety and warranty costs. Each DTC is generated by an onboard diagnostics (OBD) system using a specific method. For example, a method for generating a DTC may involve monitoring one or more variables of a subsystem, performing one or more calculations using the monitored variables, comparing the results of the calculations with respective thresholds, and generating the DTC based on the comparisons. The thresholds are empirically calibrated for a particular set of vehicles during the manufacture of the vehicles. The calibrations take into account most conditions that the vehicles may encounter on the roads. Yet some conditions may trigger a DTC when the DTC should not be triggered (false positive). Conversely, some conditions may not trigger a DTC when the DTC should be triggered (false negative). Such inconsistencies can not only inconvenience users due to false positives (e.g., by requiring unnecessary service) but can also affect vehicle emissions, safety and OBD compliance due to false negatives (e.g., by not detecting a failure that requires service).

The present disclosure provides a system and method for collecting DTC data from vehicles, validating the DTC data, and providing various indications to drivers, service personnel, and design engineers to make the DTCs robust so that the false positives and false negatives can be minimized or eliminated. To validate the DTCs and make the DTCs robust, the system and method of the present disclosure provide DTC figure-of-merits (FOMs) and in-use monitor performance ratio (IUMPR) analysis for engineers to calibrate the OBD systems. The system and method of the present disclosure are hereinafter collectively called the DTC validation system.

The DTC validation system ingests DTC data collected manually using an OBD service tool and automatically using a vehicle data recorder (VDR) onboard a vehicle. The DTC validation system ingests DTC data from vehicles in use and from developmental vehicles. The DTC validation system filters bad samples (e.g., outliers) from the ingested data, and detects and identifies DTC performance issues for a fleet of vehicles by calculating DTC metrics and comparing them with design targets. The DTC validation system suggests corrective actions to be taken by drivers, service personnel, and design engineers.

Current systems manually filter data collected from vehicles and calculate DTC metrics using approximations, which makes these systems slow and prone to errors. The speed of these systems is further reduced because in these systems, data correlations are performed manually, and individual raw data files are explored manually to detect anomalies. In contrast, the DTC validation system of the present disclosure automatically filters bad samples (e.g., outliers) and quickly detects DTC issues using physics- and machine-learning based models as explained below in further detail.

For example, the DTC validation system automatically filters data samples with bias and noise, which makes the DTC system robust and enables accurate detection and identification of DTC issues. The DTC validation system also performs comprehensive correlation analysis of the detected DTC issues with environmental variables. The DTC validation system electronically provides guidelines to drivers, service personnel, and engineers regarding actions to be taken and/or fixes to be applied to resolve the detected DTC issues.

Thus, the DTC validation system of the present disclosure improves the technical field of OBD systems in the automotive industry. Further, the teachings of the DTC validation system are applicable to other types of vehicles including but not limited to aircrafts, recreational vehicles, earth movers, and any other equipment such as appliances that rely on OBD and DTCs.

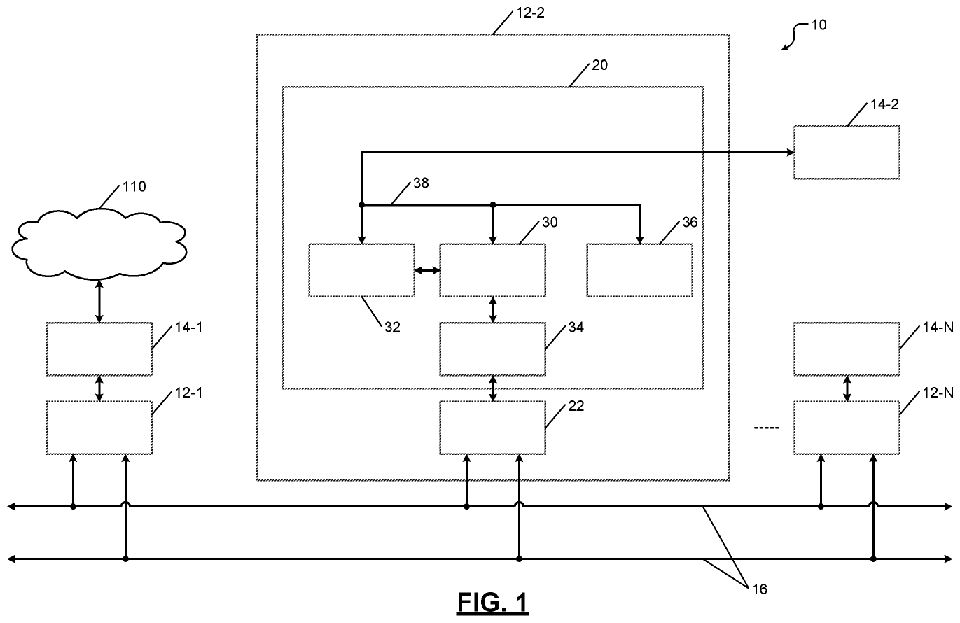

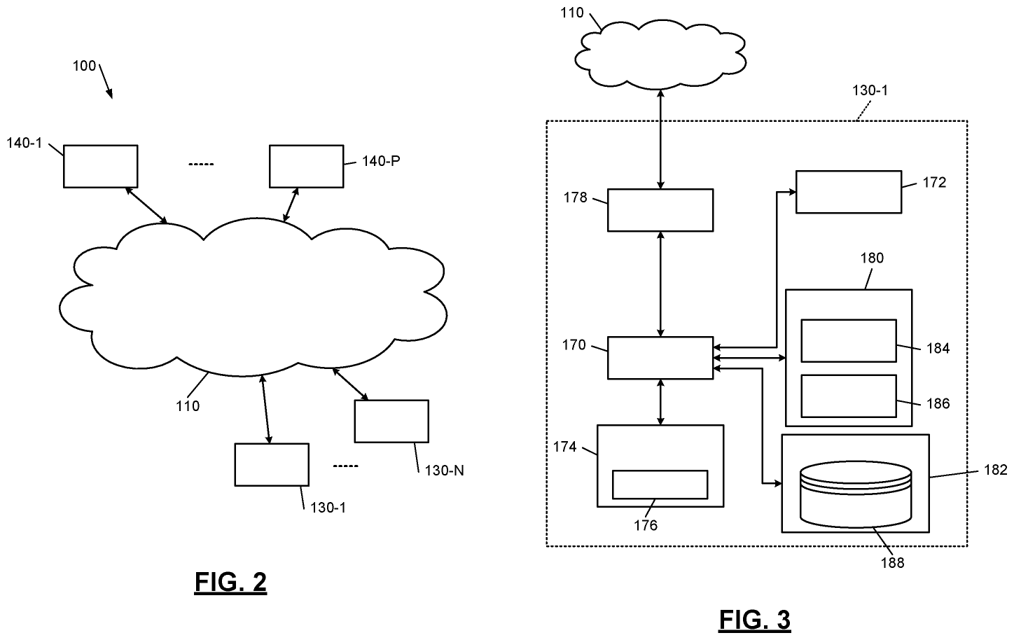

The present disclosure is organized as follows. Initially, to introduce OBD and DTCs, a system including a plurality of subsystems of a vehicle is shown and described with reference to FIG. 1. A distributed network system comprising a plurality of vehicles and one or more servers configured to implement the DTC validation system of the present disclosure is shown and described with reference to FIGS. 2 and 3. The various methods performed by the DTC validation system of the present disclosure for validating the DTCs are shown and described with reference to FIGS. 4-11. As used herein, validating a DTC means approving that the DTC meets the specified requirements.

In vehicles, control systems used to control various subsystems are typically implemented as Electronic Control Units (ECU's). The ECU's are connected to each other by a Controller Area Network (CAN) bus. Each ECU controls a specific subsystem (e.g., engine, transmission, exhaust, braking, heating and cooling, infotainment, navigation, etc.) of the vehicle. Each ECU includes a microcontroller, a CAN controller, and a transceiver. In each ECU, the microcontroller includes a processor, memory, and other circuits to control the specific subsystem. Each ECU can communicate with other ECU's via the CAN bus through the CAN controller and the transceiver.

FIG. 1 shows an example of a vehicle 10 comprising a plurality of ECU's connected to each other by a CAN bus. The plurality of ECU's includes ECU-1 12-1, . . . , and ECU-N 12-N (collectively, ECU's 12), where N is an integer greater than one. Hereinafter, ECU 12 refers to any of the plurality of ECU's 12. While FIG. 1 shows a detailed functional block diagram of only the ECU-N 12-N, other ECUs 12 have structure similar to the ECU-N 12-N. Each ECU 12 or any portion thereof can be implemented as one or more modules.

Each ECU 12 controls a respective subsystem of the vehicle 10. For example, the ECU-1 12-1 controls a subsystem 14-1, the ECU-1 12-2 controls a subsystem 14-2, . . . , and the ECU-N 12-N controls a subsystem 14-N. The subsystems 14-1, 14-2, . . . , and 14-N are collectively referred to as subsystems 14. Non-limiting examples of the subsystems 14 include an engine subsystem, a transmission subsystem, an exhaust subsystem, a brake subsystem, a traction subsystem, a suspension subsystem, a safety subsystem, an infotainment subsystem, a navigation subsystem, a communication subsystem, a physiological data acquisition subsystem, a climate control subsystem, and so on.

Each subsystem 14 may include one or more sensors to sense data from one or more components of the subsystem 14. Further, each subsystem 14 may include one or more actuators to actuate one or more components of the subsystem 14. An ECU 12 may receive data from one or more sensors of a corresponding subsystem 14. Depending on the type of subsystem 14, the ECU 12 may also receive one or more inputs from an occupant of the vehicle 10. The ECU 12 may control one or more actuators of the corresponding subsystem 14 based on the data received from the one or more sensors and/or the one or more inputs from an occupant of the vehicle 10.

The ECUs 12 are connected to a CAN bus 16. The ECUs 12 can communicate with each other via the CAN bus 16. The ECUs 12 can communicate with other devices connected to the CAN bus 16 (e.g., test equipment, a communication gateway, etc.). Each ECU 12 includes a microcontroller 20 and a CAN transceiver 22. The microcontroller 20 communicates with the subsystem 14 controlled by the ECU 12. The CAN transceiver 22 communicates with the CAN bus 16 and transmits and receives data on the CAN bus 16.

The microcontroller 20 includes a processor 30, a memory 32, a CAN controller 34, and a power supply 36. The memory 32 includes volatile memory (RAM) and may additionally include nonvolatile memory (e.g., flash memory) and/or other type of data storage device(s). The processor 30 and the memory 32 communicate with each other via a bus 38. The processor 30 executes code stored in the memory 32 to control the subsystem 14. For example, the code may include onboard diagnostics (OBD) to diagnose the subsystem 14. The power supply 36 supplies power to all of the components of the microcontroller 20 and the ECU 12. The CAN controller 34 communicates with the CAN transceiver 22.

The processor 30 can perform the OBD on the subsystem 14 and can generate one or more diagnostic trouble codes (DTCs) indicating operational status of the subsystem 14. The OBD and any sensors of the subsystem 14 are calibrated when the vehicle 10 is manufactured. The subsystems 14 may include a communication subsystem (e.g., subsystem 14-1). The communication subsystem 14-1 may include one or more transceivers for wireless (e.g., cellular, WiFi, etc.) communication, a GPS system for navigation, and so on to communicate with a distributed communications system 110. The communication subsystem 14-1 can transmit DTC data to the DTC validation system implemented in one or more servers (shown in FIG. 2) in a cloud via the distributed communications system 110. The communication subsystem 14-1 can receive software updates (e.g., for the OBD) from the DTC validation system via the distributed communications system 110.

The subsystems 14 may also include an infotainment subsystem (e.g., subsystem 14-N). While not shown, the infotainment subsystem 14-N may include a radio receiver, a satellite receiver, and one or more displays including a display console on the dashboard of the vehicle 10 and a plurality of displays including touchscreens for the occupants of the vehicle 10. The infotainment subsystem 14-N may include audiovisual multimedia subsystems and a human to machine interface (HMI) that allows occupants of the vehicle 10 to interact with one or more of the subsystems 14. The infotainment subsystem 14-N can provide audiovisual indications of the DTCs to the occupants of the vehicle 10. The infotainment subsystem 14-N can also provide alerts and/or messages received from the DTC validation system to the occupants of the vehicle 10 via the HMI.

FIG. 2 shows a simplified example of a distributed network system 100. The distributed network system 100 includes the distributed communications system 110. The distributed network system 100 includes one or more servers 130-1, 130-2, . . . , and 130-N (collectively servers 130); and one or more vehicles 140-1, 140-2, . . . , and 140-P (collectively vehicles 140), where N and P are positive integers. For example, the servers 130 may be located in a cloud. The distributed communications system 110 may include a cellular network, a satellite-based communication network, a Wi-Fi network, the Internet, or other type of network. The servers 130 may connect to the distributed communications system 110 using wireless and/or wired connections.

The servers 130 implement the DTC validation system of the present disclosure, which is described below in detail with reference to FIGS. 4-11. Each vehicle 140 is similar to the vehicle 10 described above and comprises the ECU's 12 and the subsystems 14 shown in FIG. 1. Throughout the present disclosure, communications with and by the vehicles 140 are to be understood as communications with the ECU's 12 and the subsystems 14 in the vehicles 140. For example, in each vehicle 140, the communication subsystem (e.g., the subsystem 14-1) may communicate via the distributed communications system 110 with the DTC validation system implemented in the servers 130.

FIG. 3 shows a simplified example of the servers 130 (e.g., the server 130-1). The server 130-1 typically includes one or more CPUs or processors 170, one or more input devices 172 (e.g., a keypad, touchpad, mouse, and so on), a display subsystem 174 including a display 172, a network interface 178, a memory 180, and a bulk storage 182. The network interface 178 connects the server 130-1 to the distributed network system 100 via the network 110. For example, the network interface 178 may include a wired interface (e.g., an Ethernet interface) and/or a wireless interface (e.g., a Wi-Fi, Bluetooth, near field communication (NFC), cellular, or other wireless interface). The memory 180 may include volatile or nonvolatile memory, cache, or other type of memory. The bulk storage 182 may include flash memory, one or more hard disk drives (HDDs), or other bulk storage device.

The processor 170 of the server 130-1 may execute an operating system (OS) 184 and one or more server applications 186. The server applications 186 may include an application that implements the methods described below to perform DTC validation according to the present disclosure. The bulk storage 182 may store one or more databases 188 that store data structures used by the server applications 186 to perform respective functions. The server(s) 130 and the server applications 186, which include one or more applications that implement the methods shown and described below with reference to FIGS. 4-11 to perform DTC validation, constitute the DTC validation system according to the present disclosure.

Throughout the present disclosure, references to terms such as servers, applications, and so on are for illustrative purposes only. The term server is to be understood broadly as representing a computing device comprising one or more processors and memory configured to execute machine readable instructions. The terms applications and computer programs are to be understood broadly as representing machine readable instructions executable by the computing devices.

FIG. 4 shows a method 200 for performing DTC validation according to the present disclosure. At 202, the method 200 defines rules to evaluate performance of DTCs that may be generated by a fleet of vehicles. A method of defining the rules including variables used in the rules and other parameters including but not limited to thresholds, filters, boundaries, and so on used in DTC validation is shown and described in detail with reference to FIG. 5.

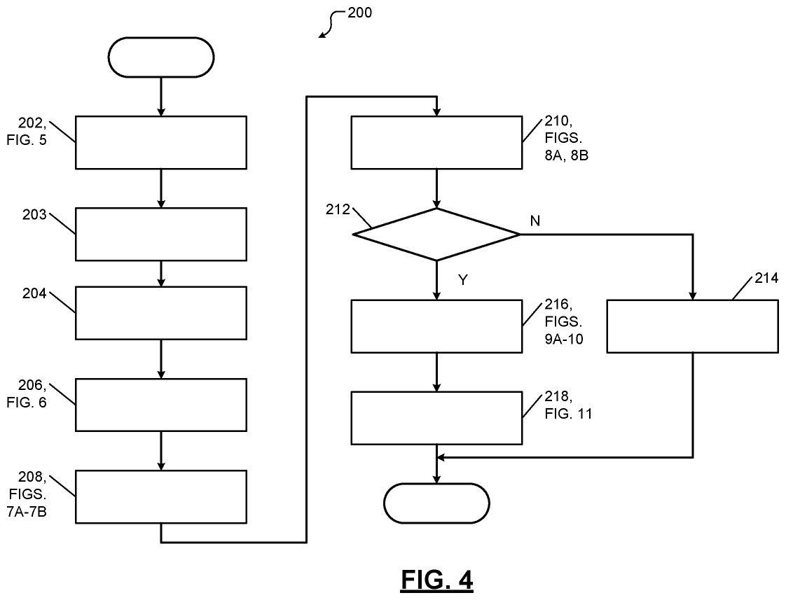

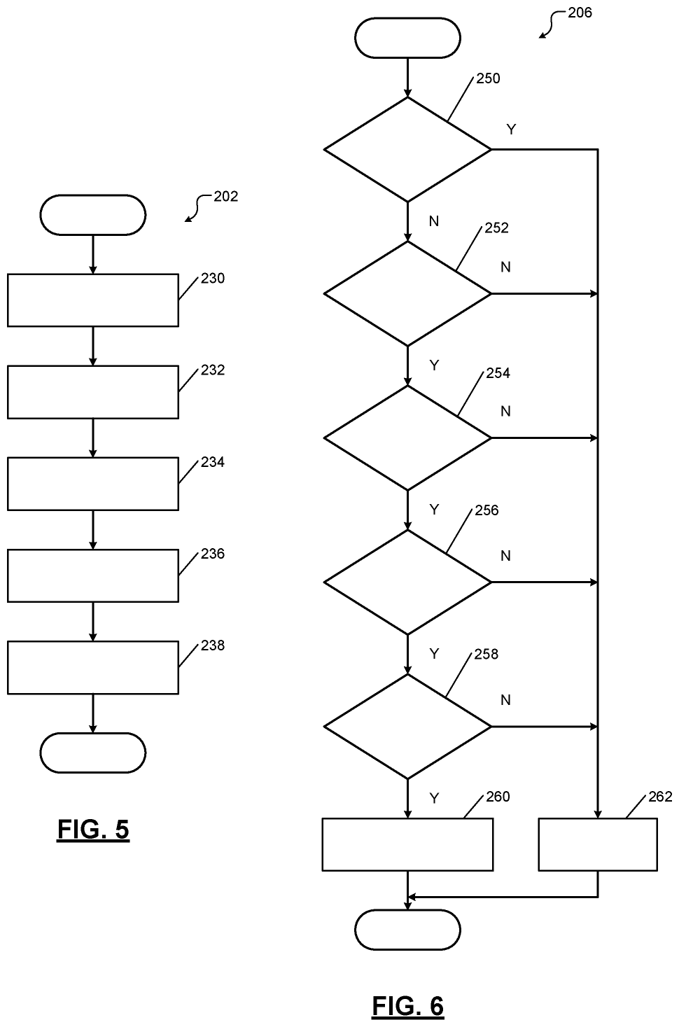

At 203, the method 200 imports variable information for the DTCs. At 204, the method 200 ingests DTC data from the vehicles. At 206, the method 200 filters premature DTC samples from the ingested DTC data using the rules. The filtering process is shown and described in detail with reference to FIG. 6.

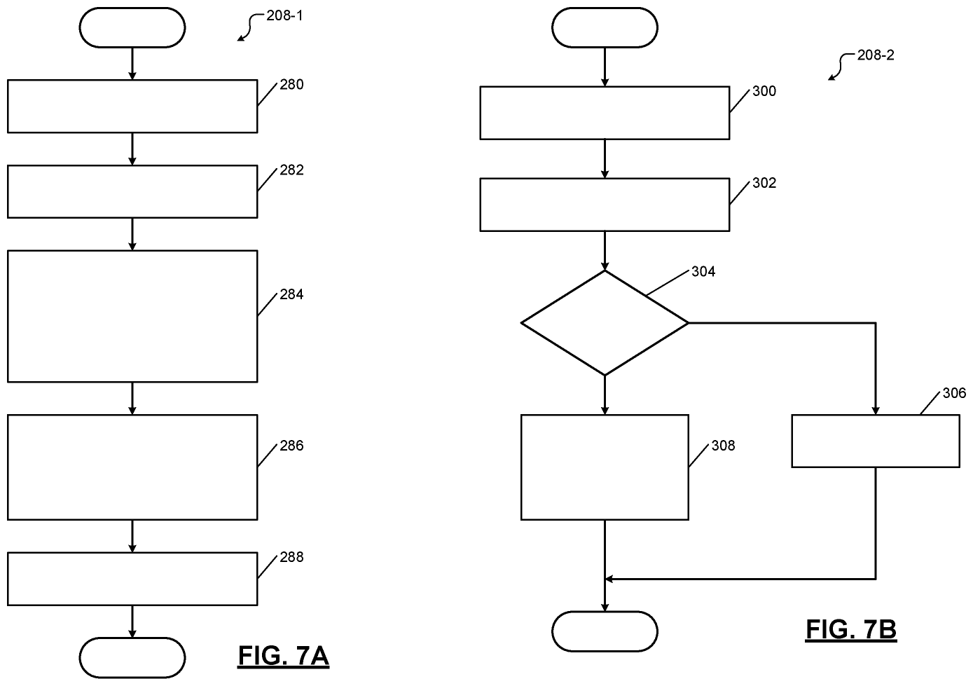

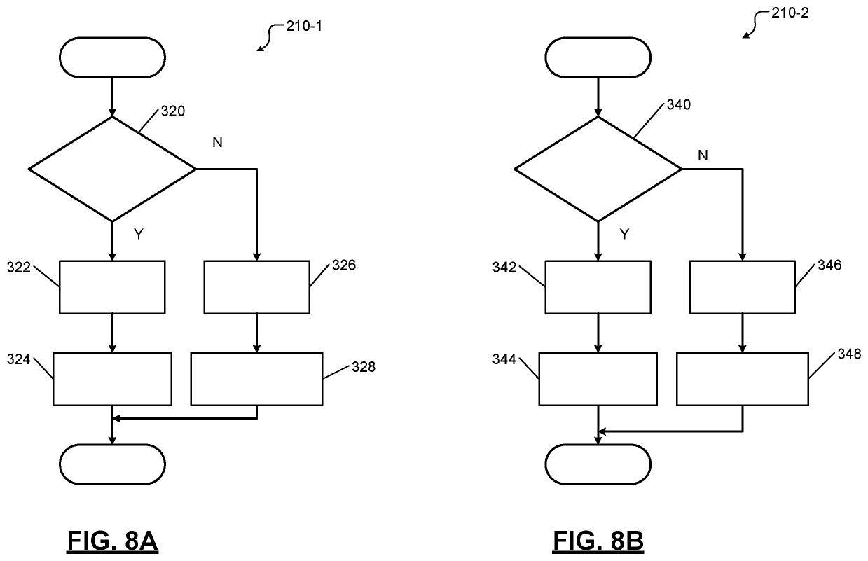

At 208, the method 200 generates metrics for a DTC using the rules. Metric generation is shown and described in detail with reference to FIGS. 7A and 7B. At 210, the method 200 detects issues with the DTC using the rules. The issue detection is shown and described in detail with reference to FIGS. 8A and 8B.

At 212, the method 200 determines if an issue is detected with the DTC. If no issue is detected with the DTC, at 214, the method 200 determines that the DTC meets the requirements (i.e., the method approves or validates the DTC as meeting the requirements), and the method 200 ends. A DTC meets the requirements when the DTC correctly indicates a problem that the DTC is designed to indicate. Accordingly, meeting the requirements indicates that the DTC is being generated correctly (i.e., procedures such as calibration, sensing data, processing data, threshold comparisons, etc. used to generate the DTC are functioning according to the specification, without generating false positives and false negatives).

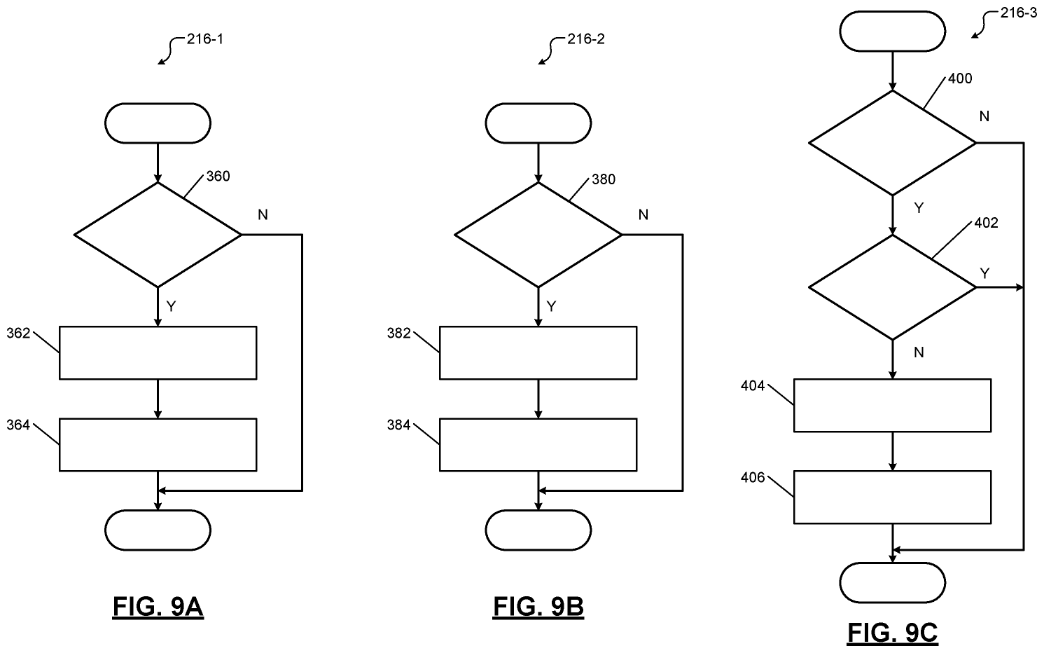

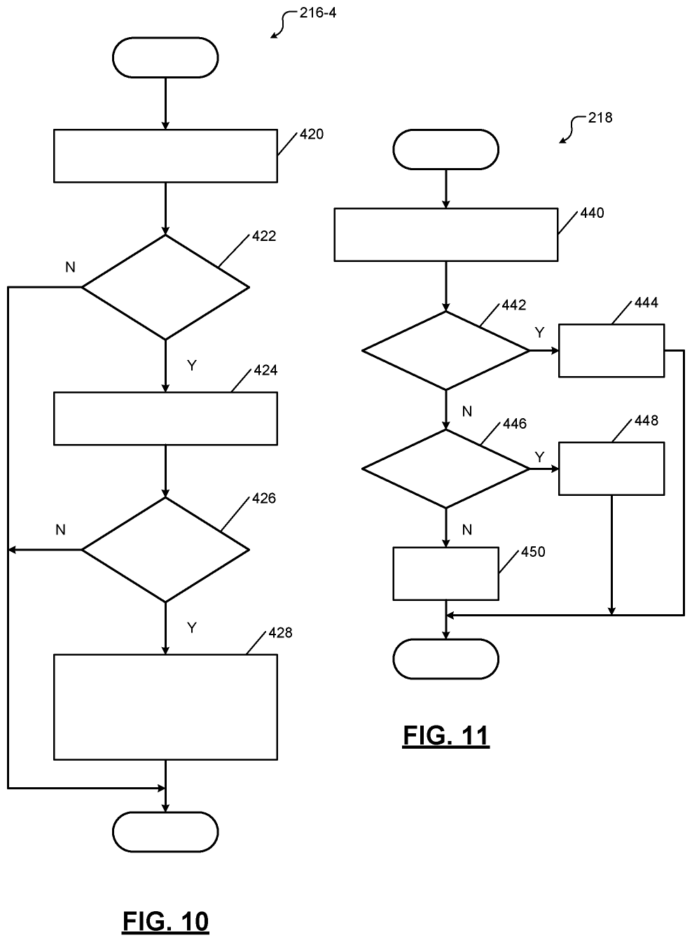

If, however, an issue is detected with the DTC, at 216, the method 200 correlates the detected issue or issues with software version and/or calibration used to generate the DTC, a vehicle identifier (e.g., vehicle identification number or VIN), and environmental variables (e.g., ambient temperature, weather conditions, road conditions, etc.). The correlation methods are shown and described in detail with reference to FIGS. 9A-10.

At 218, the method 200 categorizes the type of issue with the DTC so that a suitable corrective measure may be taken (e.g., updating the software and/or calibration used to generate the DTC, compensating for the environmental variables, scheduling hardware service, etc.). The method of categorizing the type of issue and suggesting corrective measures to address the issue is shown and described in detail with reference to FIG. 11.

FIG. 5 shows the step 202 of the method 200 (i.e., a method of defining the rules including variables used in the rules and other parameters such as thresholds, filters, boundaries etc. used in DTC validation) in further detail. At 230, the method 200 specifies variables used (e.g., in equations) to calculate each DTC for a fleet of vehicles. Additionally, the method 200 specifies other parameters including but not limited to thresholds, filters, boundaries, etc., which are used in further processing of DTC data as described with reference to FIGS. 6-11 for each DTC. At 232, the method 200 specifies filtering criteria for filtering the ingested DTC data for each DTC. The filtering process performed using the filtering criteria is shown and described in detail with reference to FIG. 6.

At 234, the method 200 specifies thresholds for calculating a figure of merit (FOM) for each DTC. Methods of calculating the FOMs are shown and described in detail with reference to FIGS. 7A and 7B. At 236, the method 200 specifies boundaries for detecting issues for each DTC. Methods for detecting issues with DTCs are shown and described in detail with reference to FIGS. 8A and 8B. At 238, the method specifies a tiered notification scheme for notifying detected issues with the DTCs. A method of notification is shown and described in detail with reference to FIG. 11.

FIG. 6 shows the step 206 of the method 200 (i.e., a method of filtering premature DTC samples) in further detail. At 252, the method 200 determines if the ingested data is from a test trip of a vehicle (e.g., trip made by the vehicle with fault insertion for diagnostic evaluation purposes). If yes, the method 200 discards the ingested data at 262 since analyzing such data does not reflect actual behavior of a DTC and therefore cannot be used for validating the DTC. If no, the method 200 proceeds to 252.

At 252, the method 200 determines if conditions for enabling generation of a DTC are met for each trip (i.e., if a DTC is being generated consistently in each trip) made by the vehicle. If no, the method 200 discards the ingested data at 262. If yes, the method 200 proceeds to 254.

At 254, the method 200 determines if the DTC was reset after a hardware related fault or injected fault was cleared (i.e., if a DTC that was set due to prior condition does not persist). If no, the method 200 discards the ingested data at 262. If yes, the method 200 proceeds to 256.

At 256, the method 200 determines if the vehicle has been driven for sufficient time to allow the data to mature. For example, an exhaust system of a vehicle may need time to warm up from a cold start before a DTC generated based on the data from the exhaust system can be valid. If no, the method 200 discards the ingested data at 262. If yes, the method 200 proceeds to 258.

At 258, the method 200 determines if the FOM variables for the DTC are not within a predetermined range of default values. If no, the method 200 discards the ingested data at 262. If yes, the method 200 proceeds to 260. At 260, after filtering the ingested data as described in steps 250 through 258, the method 200 keeps the filtered data for further processing shown in FIGS. 7A onwards.

FIGS. 7A and 7B show the step 208 of the method 200 (i.e., methods of metric generation using the filtered data from the step 260 shown in FIG. 6) in further detail. FIG. 7A shows calculation of a metric called an in-use performance monitoring ratio (IUMPR) as a step 208-1, which is part of the step 208. FIG. 7B shows calculations of metrics called FOM ratio and FOM sigma as a step 208-2, which is also part of the step 208.

In FIG. 7A, at 280, the method 200 selects a DTC and the related filtered data obtained from the filtering performed in FIG. 6. At 282, the method 200 determines if data from the trips should be included in the metric calculation by using a set of predefined filters (e.g., defined as described with reference to FIG. 5).

At 284, for each DTC, the method 200 determines a numerator, which is the number of times a vehicle has been operated such that all monitoring conditions necessary for a specific monitor to detect a malfunction have been encountered. At 286, the method 200 calculates a ratio of the numerator to a denominator, where the denominator is a counter that increments on a particular drive cycle if defined conditions for a standard drive cycle have been met.

At 288, the method 200 compares the ratio to a predetermined threshold and determines if IUMPR is sufficient (i.e., if the DTC meets the IUMPR requirement). For example, a ratio value of less than 1 (e.g., 0.336) is considered sufficient. The sufficiency of IUMPR is based on a mandated number times a diagnostic is to be run according to regulations and the actual number of times the diagnostic is run. Accordingly, a very low value (e.g., less than 0.336) of the ratio is not sufficient to meet the IUMPR requirement.

In FIG. 7B, at 300, the method 200 determines if data from the trips should be included in the metric calculation by using a set of predefined filters (e.g., defined as described with reference to FIG. 5). At 302, the method 200 selects a FOM variable and a threshold for a DTC from the rule for the DTC (e.g., defined as described with reference to FIG. 5).

At 304, from the rules defined as described with reference to FIG. 5, the method 200 determines whether the FOM type for the DTC is defined as a ratio or as a statistical parameter sigma. The method 200 proceeds to 306 if the FOM type for the DTC is defined as a ratio. The method 200 proceeds to 308 if the FOM type for the DTC is defined as a statistical parameter sigma.

At 306, the method 200 uses the value of the FOM variable from the filtered data and calculates a ratio of the FOM variable to the corresponding threshold. The method 200 processes the ratio as described below with reference to FIG. 8A. At 308, the method 200 uses the values of the FOM variable from the filtered data and calculates a mean value of the FOM variable. The method 200 determines a number of sigma's (standard deviations) by which the mean value is away from the threshold. The method 200 processes the mean value as described below with reference to FIG. 8B.

FIGS. 8A and 8B show the step 210 of the method 200 (i.e., methods of issue detection based on the metrics calculated as described with reference to FIGS. 7A and 7B) in further detail. FIG. 8A shows issue detection based on the ratio calculated shown in FIG. 7A as a step 210-1, which is part of the step 210. FIG. 8B shows issue detection based on the sigma calculation shown in FIG. 7B as a step 210-2, which is also part of the step 210.

In FIG. 8A, at 320, the method 200 determines if the ratio calculated as described with reference to FIG. 7A is less than or equal to a predetermined threshold (e.g., defined in the rules as described with reference to FIG. 5). For example, the ratio can be a type 1 ratio for a false positive DTC and a type 2 ratio for a false negative DTC. In either case, the ratio may be normalized to a value between 0 and 1. A low value of the ratio (e.g., closer to 0 than to 1) indicates that the DTC data is reliable.

If the ratio is less than or equal to the predetermined threshold, at 322, the method 200 determines that the FOM data for the DTC is within a boundary (e.g., defined in the rules as described with reference to FIG. 5). At 324, the method 200 determines that the OBD for the DTC is meeting the requirements.

If, however, the ratio is not less than or equal to the predetermined threshold, at 326, the method 200 determines that the FOM data for the DTC is not within the boundary (i.e., is out of the boundary). At 328, the method 200 determines that the OBD for the DTC is not meeting the requirements.

In FIG. 8B, at 340, the method 200 determines if the number of sigma's determined as described with reference to FIG. 8B, meets a target value (e.g., defined in the rules described with reference to FIG. 5). For example, the number of sigma's can be greater than or equal to 4 sigma's for type 1 (false positive DTC) and greater than or equal to 2 sigma's for type 2 (false negative DTC). In either case, the ratio may be normalized to a value between 0 and 1.

If the number of sigma's determined meets the target value, at 342, the method 200 determines that the FOM data for the DTC is within a boundary (e.g., defined in the rules as described with reference to FIG. 5). At 344, the method 200 determines that the OBD for the DTC is meeting the requirements.

If, however, the number of sigma's determined does not meet the target value, at 326, the method 200 determines that the FOM data for the DTC is not within the boundary (i.e., is out of the boundary). At 348, the method 200 determines that the OBD for the DTC is not meeting the requirements.

FIGS. 9A-9C and 10 show the step 216 of the method 200 (i.e., methods of correlating the detected issue or issues with software version and/or calibration, VIN, and environmental variables in further detail. FIG. 9A shows correlation with software version as a step 216-1, which is part of the step 216. FIG. 9B shows correlation with VIN as a step 216-2, which is part of the step 216. FIG. 9C shows correlation with environmental variables as a step 216-2, which is part of the step 216. FIG. 10 shows correlation of outlier data with these factors as a step 216-4, which is also part of the step 216.

In FIG. 9A, at 360, the method 200 determines if the FOM data for the DTC is out of boundary (as determined at step 326 in FIG. 8A or at step 346 in FIG. 8B). If the FOM data for the DTC is out of boundary, at 362, the method 200 filters the FOM data based on the software version or the calibration version that is being used to generate the DTC. At 364, the method 200 identifies the software version or the calibration version that is causing issues with the DTC.

In FIG. 9B, at 380, the method 200 determines if the FOM data for the DTC is out of boundary (as determined at step 326 in FIG. 8A or at step 346 in FIG. 8B). If the FOM data for the DTC is out of boundary, at 382, the method 200 filters the FOM data based on VIN. At 364, the method 200 identifies the vehicle or vehicles having issues with the DTC.

In FIG. 9C, at 400, the method 200 determines if the FOM data for the DTC is out of boundary (as determined at step 326 in FIG. 8A or at step 346 in FIG. 8B). If the FOM data for the DTC is out of boundary, at 402, the method 200 determines if the issues with the DTC are due to the software or calibration versions (determined as described with reference to FIG. 9A) or VIN (determined as described with reference to FIG. 9B). If the issues with the DTC are due to neither the software or calibration versions nor the VIN, at 404, the method 200 correlates the FOM data of the DTC with one or more environmental variables (e.g., ambient temperature, roughness of road, etc.). At 406, the method 200 identifies the environmental variable having the highest correlation as causing issues with the DTC.

In FIG. 10, at 420, the method 200 inputs the FOM data for a DTC to a machine learning based outlier detector. At 422, the method 200 determines if any outliers are detected in the FOM data for the DTC. If any outliers are detected, at 424, the method 200 correlates the outliers with the software or calibration versions, VINs, and environmental variables. At 426, the method 200 determines if a strong correlation exists between the outliers and any of the factors including the software or calibration version, VIN, and environmental variables. If yes, at 430, the method 300 determines or identifies the root cause or causes for the outliers based on the factors with which the outliers have the strongest (highest) correlation.

FIG. 11 shows the step 218 of the method 200 (i.e., a method of categorizing the type of issue with the DTC and suggesting corrective measures) in further detail. At 440, the method 200 ensures that the rules and related parameters (e.g., thresholds, filters, boundaries, etc.) defined in FIG. 5 are correct (e.g., from design and engineering perspective). At 442, the method 200 determines if the issue with the DTC is due to a particular software version or calibration version (based on the correlation described with reference to FIGS. 9A-10). If yes, at 444, the method 200 updates the software associated with the DTC. If no, the method 200 proceeds to 446.

At 446, the method 200 determines if the issue with the DTC correlates with a particular VIN or VINs. If yes, at 448, the method 200 provide an indication to service the vehicle hardware (e.g., a subsystem indicated faulty by the DTC). If no, the method 200 proceeds to 450. At 450, the method updates the software or the calibration for the DTC.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module,” “controller,” or “subsystem” may be replaced with the term “circuit.” The terms “module,” “controller,” and “subsystem” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip. Further, the term “subsystem” may comprise a module and/or a controller and may additionally comprise one or more sensors and actuators to provide the described functionality.

The module, controller, and subsystem may include one or more interface circuits. In some examples, the interface circuits may include wired or wireless interfaces that are connected to a local area network (LAN), the Internet, a wide area network (WAN), or combinations thereof. The functionality of any given module, controller, and subsystem of the present disclosure may be distributed among multiple modules, controllers, and subsystems that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules, controllers, and subsystems. The term group processor circuit encompasses a processor circuit that, in combination with additional processor circuits, executes some or all code from one or more modules, controllers, and subsystems. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules, controllers, and subsystems. The term group memory circuit encompasses a memory circuit that, in combination with additional memories, stores some or all code from one or more modules, controllers, and subsystems.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for validating diagnostic trouble codes (DTCs) in vehicles, the system comprising:
a processor; and
a memory storing instructions which when executed by the processor configure the processor to:
receive DTC data from the vehicles;
filter the DTC data using predefined rules;
generate one or more metrics based on the filtered DTC data; and
determining based on the metrics whether the DTCs meet specifications for the DTCs.

2. The system of claim 1 wherein the processor is configured to:
detect problems with the DTCs based on the metrics and the predefined rules;
correlate the problems with software and calibration versions used to generate the DTCs, vehicle identification numbers (VINs) of the vehicles, and environmental variables; and
identify a root cause for the problems with the DTCs.

3. The system of claim 2 wherein the processor is configured to provide an indication regarding updating software or calibration versions based on the correlation with the software and calibration versions.

4. The system of claim 2 wherein the processor is configured to provide an indication regarding servicing one or more of the vehicles based on the correlation with the VINs.

5. The system of claim 2 wherein the processor is configured to provide an indication regarding modifying at least one of the software or calibration versions based on the correlation with the VINs.

6. The system of claim 1 wherein the processor is configured to filter the DTC data based on one or more of:
whether the DTC data is from a test vehicle;
conditions to generate the DTCs are met for each drive cycle;
the DTCs were reset after corresponding fault was cleared;
the DTCs are generated after the vehicles have been driven for a period of time; and
whether variables used to generate the metrics are within respective ranges of default values.

7. The system of claim 1 wherein one of the metrics is an in-use monitor performance ratio (IUMPR) and wherein the processor is configured to determine whether one of the DTCs meets a corresponding specification based on whether the IUMPR for the one of the DTCs is within a predetermined range.

8. The system of claim 1 wherein one of the metrics is of a ratio type and wherein the processor is configured to determine whether one of the DTCs meets a corresponding specification based on whether a ratio of a variable for the one of the DTCs to a corresponding threshold is within a predetermined limit.

9. The system of claim 1 wherein one of the metrics is of a statistical type and wherein the processor is configured to determine whether one of the DTCs meets a corresponding specification based on whether a mean value of a variable for the one of the DTCs is a predetermined number of standard deviations away from a corresponding threshold.

10. The system of claim 1 wherein the processor is configured to:
detect outliers in data corresponding to a variable selected as a figure of merit variable for one of the DTCs;
correlate the outliers with software and calibration versions used to generate the DTCs, vehicle identification numbers (VINs) of the vehicles, and environmental variables; and
identify a root cause for the problems with the one of the DTCs.

11. A method for validating diagnostic trouble codes (DTCs) in vehicles, the method comprising:
receiving DTC data from the vehicles;
filtering the DTC data using predefined rules;
generating one or more metrics based on the filtered DTC data; and
determining based on the metrics whether the DTCs meet specifications for the DTCs.

12. The method of claim 11 further comprising:
detecting problems with the DTCs based on the metrics and the predefined rules;
correlating the problems with software and calibration versions used to generate the DTCs, vehicle identification numbers (VINs) of the vehicles, and environmental variables; and
identifying a root cause for the problems with the DTCs.

13. The method of claim 12 further comprising providing an indication regarding updating software or calibration versions based on the correlation with the software and calibration versions.

14. The method of claim 12 further comprising providing an indication regarding servicing one or more of the vehicles based on the correlation with the VINs.

15. The method of claim 12 further comprising providing an indication regarding modifying at least one of the software or calibration versions based on the correlation with the VINs.

16. The method of claim 11 further comprising filtering the DTC data based on one or more of:
whether the DTC data is from a test vehicle;
conditions to generate the DTCs are met for each drive cycle;
the DTCs were reset after corresponding fault was cleared;
the DTCs are generated after the vehicles have been driven for a period of time; and
whether variables used to generate the metrics are within respective ranges of default values.

17. The method of claim 11 wherein one of the metrics is an in-use monitor performance ratio (IUMPR), the method further comprising determining whether one of the DTCs meets a corresponding specification based on whether the IUMPR for the one of the DTCs is within a predetermined range.

18. The method of claim 11 wherein one of the metrics is of a ratio type, the method further comprising determining whether one of the DTCs meets a corresponding specification based on whether a ratio of a variable for the one of the DTCs to a corresponding threshold is within a predetermined limit.

19. The method of claim 11 wherein one of the metrics is of a statistical type, the method further comprising determining whether one of the DTCs meets a corresponding specification based on whether a mean value of a variable for the one of the DTCs is a predetermined number of standard deviations away from a corresponding threshold.

20. The method of claim 11 further comprising:
detecting outliers in data corresponding to a variable selected as a figure of merit variable for one of the DTCs;
correlating the outliers with software and calibration versions used to generate the DTCs, vehicle identification numbers (VINs) of the vehicles, and environmental variables; and
identifying a root cause for the problems with the one of the DTCs.
